(19) United States
(12) Patent Application Publication
(10) Pub. No.: US 2011/0297861 A1
(43) Pub. Date: Dec. 8, 2011

(54) Angle Of Repose Valve

(75) Inventors: Robert Cronin, Houston, TX (US); Robert Cook, O'Fallon, MO (US); Lee Ferry, St. Charles, MO (US); Satish Bhusarapu, Houston, TX (US)

(73) Assignee: MEMC ELECTRONIC MATERIALS, INC., St. Peters, MO (US)

(21) Appl. No.: 12/796,355

(22) Filed: Jun. 8, 2010

(51) Int. Cl. F16K 5/00

(52) U.S. Cl. 251/304; 137/15.08

(57) ABSTRACT

An angle of repose valve for controlling the flow of granules and a method of repairing a leak in an angle of repose valve are disclosed herein. The angle of repose valve has a housing with an interior cavity, an inlet, and an outlet. A gas is used to convey granules through the valve and the housing has a thickness such that the gas can have a pressure of at least 70 psi. A saddle is disposed in the interior cavity of the housing and is coupled to a rotatable shaft that passes through an opening in the housing. A chevron seal is disposed between the shaft and a sealing member. A compression member is threadably engaged with the sealing member and is operable to exert force on the chevron seal to expand the chevron seal against the shaft and/or the housing to prevent and/or repair leaks of gas therethrough.

### BACKGROUND

Granular solids of high purity are often used, for example, in the manufacture of silicon products including semiconductor wafers. Valves are used to control the flow of the granular solids. Conventional valves, such as ball or gate valves, are ill-suited for controlling the flow of the granules in the manufacturing process. The use of conventional valves often results in material being abraded from the valves and contaminating the granules. Moreover, conventional valves may be unable to completely close and stop the flow of granules because granules may become trapped between valve components. Angle of repose valves have been developed to address these issues. However, previous angle of repose valves suffered shortcomings. For example, prior seals cannot withstand higher gas pressures.

### BRIEF SUMMARY

A first aspect is an angle of repose valve for dispensing high purity granules. The valve comprises a housing having an inlet, an outlet, an opening having a circumferential edge, and an interior cavity. A pipe extends from the inlet into the interior cavity of the housing and the pipe has a terminal end in the interior cavity of the housing. A saddle is disposed in the interior cavity of the housing. The saddle is also disposed vertically below the terminal end of the pipe and the saddle has a catch member. A shaft is coupled to the saddle and extends through the circumferential edge of the opening in the housing and is configured for coupling to a drive. A chevron seal is disposed adjacent at least the circumferential edge defining the opening in the housing through which the shaft extends and the chevron seal has a void through which the shaft passes. A compression member is engaged with the housing and is configured to exert force on the chevron seal to expand the chevron seal against at least one of the circumferential edge of the opening in the housing and the shaft. The saddle is rotatable by the shaft between a first position and a second position, wherein in the first position high purity granules are enabled to flow unimpeded by the catch member, and wherein in the second position the catch member is disposed vertically beneath the terminal end of the pipe such that high purity granules cannot flow past the saddle.

Another aspect is an angle of repose valve for dispensing high purity granules. The valve comprises a housing having an inlet and an outlet, the housing comprising a plurality of walls having a thickness of at least about 0.95 inches. A pipe extends from the inlet into an interior cavity of the housing and the pipe has a terminal end in the interior cavity of the housing. A saddle is disposed in the interior cavity of the housing vertically below the terminal end of the pipe. The saddle is coupled to a shaft extending through an opening in the housing. A seal plate is coupled to an exterior surface of the housing and has an opening therein disposed adjacent the opening in the housing. The seal plate has a groove formed therein sized for receiving an o-ring and is configured such that the valve is able to dispense the high purity granules with a gas having a pressure of at least about 80 pounds per square inch.

Still another aspect is an angle of repose valve for dispensing high purity granules with a pressurized gas. The valve comprises a housing having an inlet, an outlet, an opening having a circumferential edge, and an interior cavity. The housing has a plurality of walls having a thickness of at least about 0.95 inches. A pipe extends into the interior cavity of the housing and has a terminal end in the internal cavity. A saddle is disposed in the interior cavity of the housing vertically below the terminal end of the pipe. A shaft is coupled to the saddle and extends through the opening in the housing. A chevron seal is disposed adjacent at least the circumferential edge of the opening in the housing through which the shaft extends. The chevron seal has a void through which the shaft passes. A compression member is threadably engaged with the housing and configured to exert force on the chevron seal when rotated in one of a clockwise direction and a counter clockwise direction. The force exerted on the chevron seal causes it to expand against at least one of the circumferential edge of the opening in the housing and the shaft.

Still another aspect is a method of repairing a leak in an angle of repose valve for dispensing high purity granules with a pressurized gas. The angle of repose valve comprises a housing and a saddle disposed therein, a shaft coupled to the saddle and extending through an opening in the housing, a chevron seal positioned between the shaft and the opening in the housing, and a compression member threadably engaged with the housing and configured to exert a compression force on the chevron seal upon tightening of the compression member. The method comprises detecting a first leak of one of the pressurized gas and high purity granules through the opening in the housing. The compression member is then tightened by a first amount when the first leak is detected. Tightening the compression member by the first amount results in a first force being exerted on the chevron seal that expands the chevron seal laterally between the shaft and the opening in the housing to repair the first leak by reducing or eliminating the first leak. Tightening the compression member by the first amount permits rotation of the shaft with respect to the opening in the housing.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a partially schematic view of an angle of repose valve system;

FIG. 2 is a front view of a first embodiment of an angle of repose valve for use in the valve system of FIG. 1;

FIG. 3 is a top view of the angle of repose valve of FIG. 2;

FIG. 4 is a perspective view of the angle of repose valve of FIG. 1 with portions of the valve removed;

FIG. 5 is a partial cross-sectional view of the angle of repose valve of FIG. 2;

FIG. 6 is a front view of a second embodiment of an angle of repose valve for use in the valve system of FIG. 1;

FIG. 7 is a top view of the angle of repose valve of FIG. 6;

FIG. 8 is a partial cross-sectional view of the angle of repose valve of FIG. 6;

FIG. 9 is a side view of a chevron seal for use in the angle of repose valve of FIG. 6; and

FIG. 10 is a flow diagram depicting a method of repairing a leak in an angle of repose valve.

### DETAILED DESCRIPTION

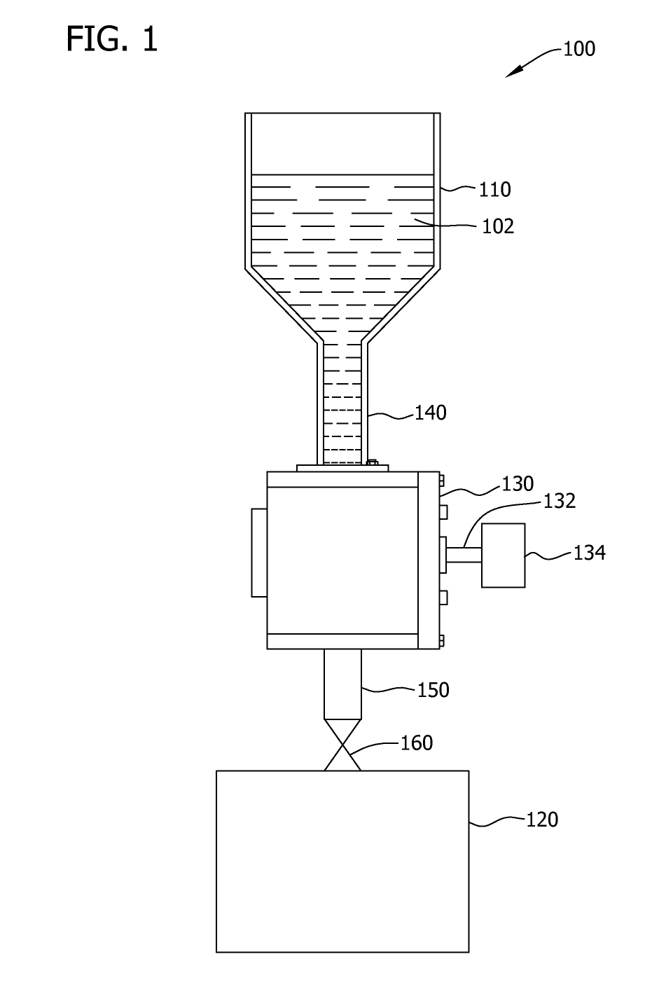

With reference now to the Figures, and in particular to FIG. 1, an angle of repose valve system is generally indicated at 100 and hereinafter referred to as a “valve system”. The valve system 100 of FIG. 1 is used to control the flow of granules 102 from a first container 110 to a second container 120. In one embodiment, the granules 102 are raw materials (e.g., granular polysilicon) used in the manufacture of silicon products including semiconductor wafers. In other embodiments, the granules 102 may be other material that is small enough in size so that it is capable of flowing into and out of the valve system 100 and may thus range in size from about 0.060 inches to about 1.0 inch in diameter.

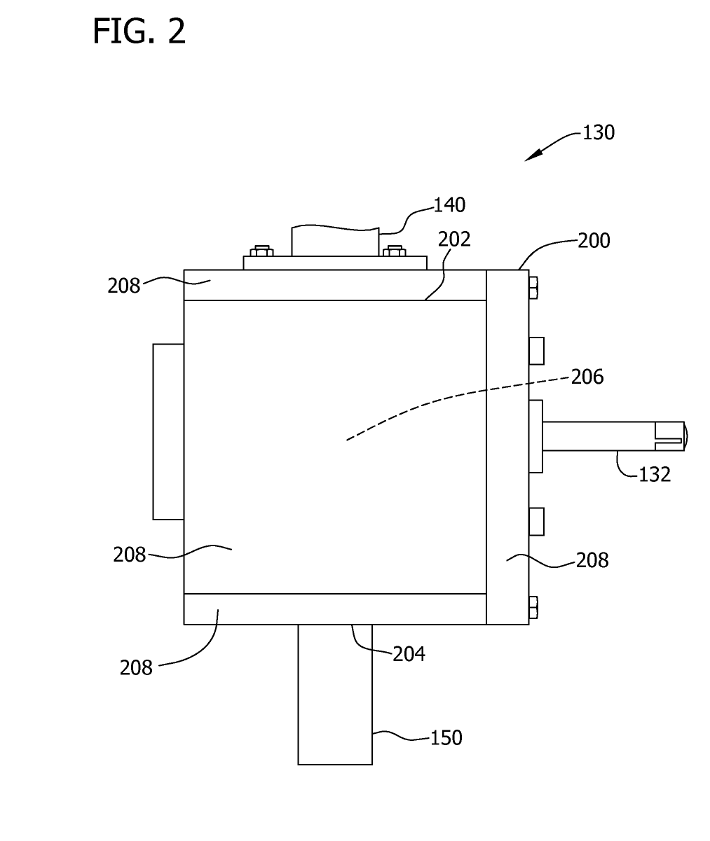

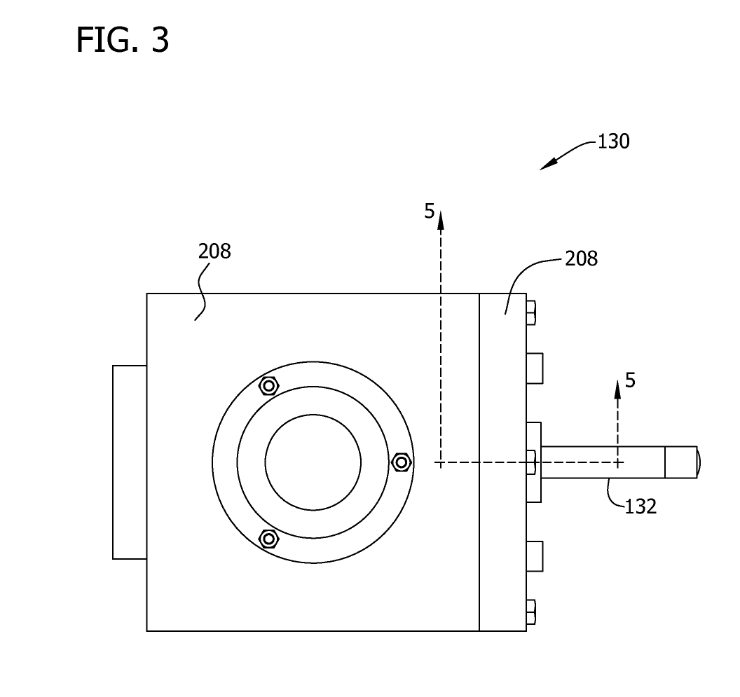

In the valve system 100 of FIG. 1, the first container 110 is disposed vertically above an angle of repose valve 130 and the second container 120 is disposed vertically beneath the angle of repose valve. Various embodiments of the angle of repose valve 130 are shown in FIGS. 2-8 and discussed in greater detail below. A shaft 132 is coupled to and extends outwardly from the angle of repose valve 130. The shaft 132 is in turn coupled to a drive source 134 (e.g., a motor or an actuator) that is operable to rotate the shaft and components of the angle of repose valve 130 connected to the shaft. The drive source 134 is controlled by a suitable control system (not shown).

A first pipe 140 couples the first container 110 to the angle of repose valve 130 and permits the granules 102 to flow from the first container into the angle of repose valve. The first container 110 is coupled to a source of pressurized gas in this embodiment to aid in the flow of granules 102 from the first container into the first pipe 140 and the angle of repose valve 130. In another embodiment, pressurized gas is not used and instead gravity is solely relied upon to convey the granules 102 from the first container 110 into the first pipe 140 and the angle of repose valve 130.

A second pipe 150 couples a conventional valve 160 to the angle of repose valve 130. The conventional valve 160 is any type of valve that is capable of preventing the flow of gas therethrough (e.g., a gate valve or a ball valve). The conventional valve 160 is in turn connected to the second container 120. In operation the second valve 160 is opened before the angle of repose valve 130 and closed after the angle of repose valve is closed. Therefore the angle of repose valve 130 is used to control the flow of granules 102 from the first container 110 into the second container 120, while the conventional valve 160 is used to prevent the flow of pressurized gas from the first container into the second container.

With reference now to FIGS. 2-6, a first embodiment of the angle repose valve 130 of FIG. 1 is shown in greater detail. The angle of repose valve 130 has a housing 200, an inlet 202, an outlet 204, and an interior cavity 206. The housing 200 is formed from multiple plates 208 (broadly, “walls”) having a thickness such that the pressure of gas used to convey the granules 102 from the first container 110 into the angle of repose valve 130 and into the second container 120 can be significantly increased compared to prior valves. In the embodiment of FIGS. 2-5, the plates 208 have a thickness such that gas pressurized to at least 70 pounds per square inch can be used to convey the granules 102 without damaging the housing 200. In other embodiments, the plates 208 have a thickness such that gas pressurized to at least 86 pounds per square inch or even 120 pounds per square inch can be used to convey the granules 102 without damaging the housing 200. In these embodiments, the plates 208 have a thickness of at least about 0.9 inches, while in other embodiments the plates have a thickness of at least about 0.95 inches, and in still other embodiments have a thickness greater than about 1.0 inch. Moreover, the thickness of the plates 208 can be further increased (e.g., greater than 1.2, 1.5, 1.8, or 2.0 inches) in order to permit the use of gas at higher pressures.

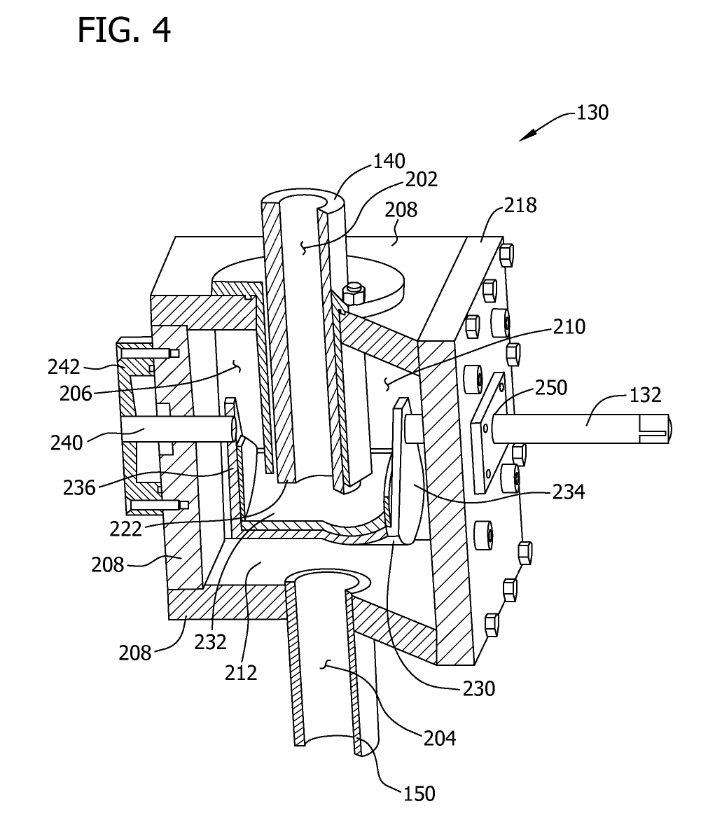

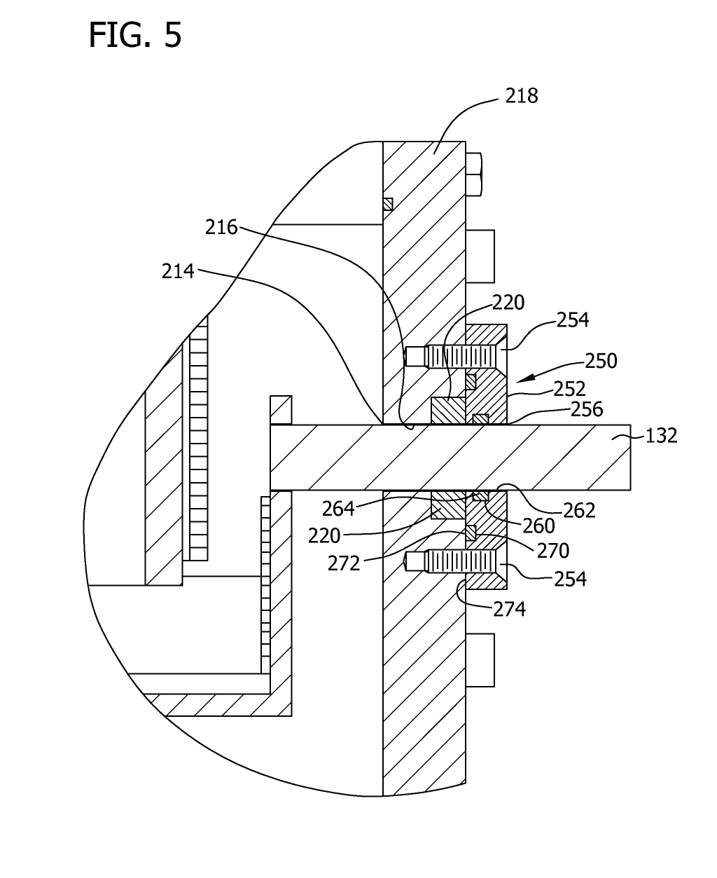

As best seen in FIG. 4, the first pipe 140 extends into an upper portion 210 of the interior cavity 206 while the second pipe 150 terminates adjacent a lower portion 212 of the interior cavity. An opening 214 having a circumferential edge 216 is formed in a side 218 of the housing 200. The opening 214 is formed completely through the side 218 of the housing 200 and is sized such that the shaft 132 is able to pass therethrough. As shown in FIG. 5, a portion of the opening 214 has an increased diameter such that packing material 220 can be placed between the circumferential edge 216 of the opening and the shaft 132.

As shown in FIG. 4, the first pipe 140 extends into the interior cavity 206 of the housing 200 and has a terminal end 222 in the interior cavity. The terminal end 222 of the first pipe 140 is disposed directly above a saddle 230. The saddle 230 has a curved catch member 232 and a first vertical member 234 connected to a first end of the catch member and a second vertical member 236 connected to a second end of the catch member. The first vertical member 234 is connected to the shaft 132 while the second vertical member 236 is connected to a stub shaft 240 that is in turn coupled by a bearing 242 to the housing 200.

The saddle 230 is rotatable by the shaft 132 between a first position where the granules 102 are enabled to flow through the angle of repose valve 130 without interference from the saddle and a second position (FIG. 4) where the granules cannot flow through the angle of repose valve. In the second position, the catch member 232 is disposed vertically beneath the terminal end 222 of the first pipe 140 such that granules 102 flowing from the terminal end contact the catch member. The catch member 232 sufficiently impedes the flow of granules 102 in the second position such that the granules accumulate on the catch member in a pile that restricts the flow of further granules from the first container 110 into the angle of repose valve 130. The granules 102 that accumulate on the catch member 232 in the pile have an angle of repose that is specific to the material properties of the granules. The angle of repose of bulk or granular materials, such as the granules 102, is generally defined as the angle formed by the inclined plane of the pile and a horizontal surface beneath the pile such that a particular piece of material is just at the verge of sliding down the inclined plane.

Once rotated from the second position to the first position, the catch member 232 of the saddle 230 is rotationally displaced such that it does not impede the flow of granules 102 from the terminal end 222 of the first pipe 100 through the angle of repose valve 130 into the second pipe 150. In operation, the flow of granules 102 is stopped by rotating the saddle 230 back to the second position. Once the flow of granules 102 through the conventional valve 160 (FIG. 1) has ceased, the convention valve is closed by an operator or actuator (not shown) and the flow of pressurized gas out of the angle of repose valve 130 is stopped. Likewise, prior to the angle of repose valve 130 being rotated back to the first position, the conventional valve 160 is opened and then the angle of repose valve is rotated to the first position. In other embodiments, a differently configured saddle may be used that has openings or other structures formed therein that is operable to selectively impede the flow of granules 102 through the angle of repose valve 130.

A seal 250 (FIG. 5) is used to prevent leakage of the pressurized gas (and granules 102) through the opening 214 in the housing 200 which the shaft 132 passes through. The seal 250 includes a seal plate 252 coupled to the exterior surface of the housing 200 by a fastener 254 or other coupling mechanism. The seal plate 252 has an opening 256 formed therein that is a slightly larger than a diameter of the shaft 132 to permit the shaft to pass through the opening in the seal plate. The opening 256 is also sized such that it does not appreciably impede rotation of the shaft 132. For example, the difference between the diameter of the opening 256 and the diameter of the shaft 132 may be about 0.02 inches.

A first groove 260 is formed in a circumferential surface 262 of the opening 256 and is sized to receive a first o-ring 264 therein. The first o-ring 264 prevents the leakage of pressurized gas between the circumferential surface 262 of the opening 256 and the shaft 132. Forming the first groove 260 in the circumferential surface 262 of the opening significantly reduces the complexity of machining the groove compared to previous systems in which the groove was formed in a welded portion of the plates 208. A second groove 270 is formed for a second o-ring 272 in an inner surface 274 of the seal plate 252 that abuts the exterior surface of the housing 200 of the angle of repose valve 130 to prevent leakage of pressurized gas between the exterior surface of the housing and the inner surface of the seal plate. Forming the second groove 270 in the seal plate 252 significantly reduces manufacturing costs as the seal plate can be formed from a softer or more easily machined material than the housing 200 because the pressurized gas does not exert appreciable force on the seal plate.

The increased thickness of the plates 208 forming the housing 200, along with the first o-ring 264 and second o-ring 272, permit the pressure of the gas to be increased significantly compared to prior systems. As such, the flow of granules 102 through the angle of repose valve 130 is likewise capable of being significantly increased since the flow of granules 102 is at least partially dependent on the pressure of the gas. Moreover, the increased gas pressure also permits a process performed in the first container 110 or in another container coupled thereto to be performed at a greater rate.

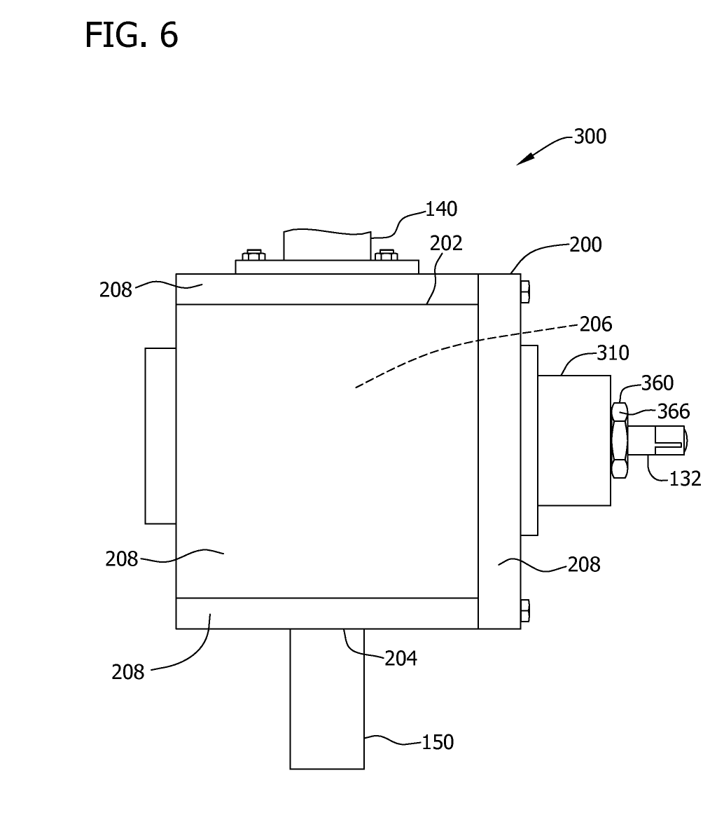

With reference now to FIGS. 6-9, a second embodiment of an angle repose valve similar to that of FIGS. 2-5 is shown and indicated generally at 300. The internal components of the angle of repose valve 300 are the same as or similar in function to those described in FIGS. 2-6 and are referred to be the same reference numerals. The angle of repose valve 300 and the angle of repose valve 130 differ in the sealing system used to prevent the flow of pressurized gas from the housing 200 of the valve through the opening 214 in the valve surrounding the shaft 132.

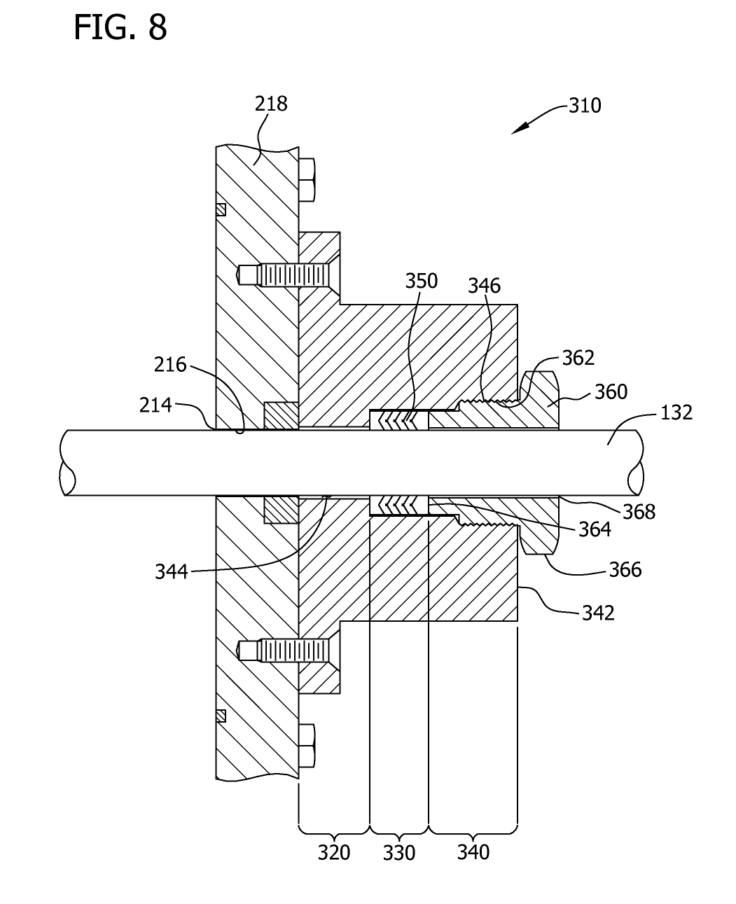

As shown in FIG. 8, a sealing member 310 is coupled to the exterior surface of the housing 200 adjacent an area of the housing surrounding the circumferential edge 216 of the opening 214 in the housing. The sealing member 310 has three portions: a first portion 320 disposed adjacent the exterior surface of the housing, a second portion 330 extending outward from the first portion, and a third portion 340 extending outward from the second portion to a terminal edge 342 of the sealing member.

The sealing member 310 also has a void 344 therein that permits the shaft 132 to pass therethrough. The void 344 has a first diameter in the first portion 320 of the sealing member 310 that is slightly larger than the diameter of the shaft 132 to permit the shaft to pass through the first portion. The void 344 is also sized such that it does not appreciably impede rotation of the shaft 132. The diameter of the void 344 then increases in the second portion 330 of the sealing member 310 to accommodate a chevron seal 350 placed therein and discussed in greater below. The diameter of the void 344 in the third portion 340 may increase or decrease compared to that of the second portion 330 in order to accommodate multiple threads 346 formed on the circumferential surface of the void 344 in the third portion.

The threads 346 formed in the third portion 340 are configured to engage threads 362 disposed on an external surface of a jam nut 360 (broadly, a “compression member”) and permit the jam nut to laterally move with respect to a longitudinal axis of the void 344 upon rotation of the jam nut. For example, when the jam nut 360 is turned in a clockwise direction, it moves inward towards the housing 200. When the jam nut 360 is turned in the counter clockwise direction it moves outward away from the housing 200. Thus, when the jam nut 360 is turned in the clockwise direction its leading edge 364 acts upon the chevron seal 350 and exerts force thereon. Once the leading edge 364 contacts the chevron seal 350, additional clockwise rotation of the jam nut 360 results in additional compression of the chevron seal.

In the embodiment of FIGS. 6-9, the jam nut 360 has multiple flats 366 on an exposed portion shaped like a hex head of a bolt such that the jam nut can be rotated with standard hand tools (e.g., a box end wrench, an adjustable wrench, or a pair of pliers) or manually by a user's hand. Moreover, while the threads 346 of the sealing member 310 are configured in this embodiment such that clockwise rotation of the jam nut 360 results in movement of the jam nut towards the housing 200 (i.e., the threads are right-handed), other embodiments may use differently pitched (e.g., finer or coarser) or differently oriented (e.g., left-handed) threads without departing from the scope of the embodiments. The jam nut 360 also has an opening 368 formed therein that is parallel to the longitudinal axis of the jam nut and sized such that the shaft 132 is able to pass therethrough. The diameter of the opening 368 in the jam nut 360 is slightly larger than a diameter of the shaft 132 to permit the shaft to pass through the opening in the jam nut. The opening 368 is also sized such that it does not appreciably impede rotation of the shaft 132.

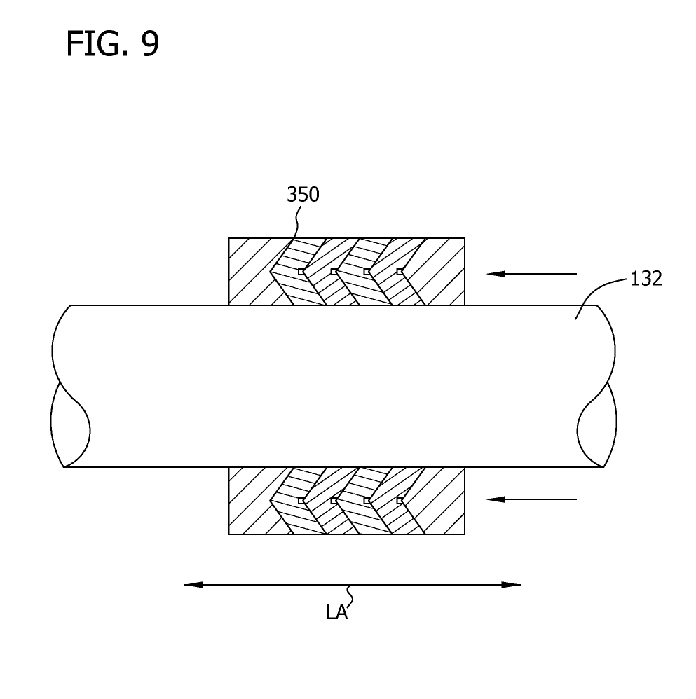

With reference now to FIG. 9, the chevron seal 350 is shown in greater detail. The chevron seal 350 may otherwise be referred to as a vee seal and operates to outwardly expand upon application of a force parallel to a longitudinal axis LA of the chevron seal. Accordingly, application of force by the leading edge 364 of the jam nut 360 results in outward, lateral expansion of the chevron seal 350 in a direction perpendicular to the longitudinal axis LA of the chevron seal. Outward expansion of the chevron seal 350 in turn results in the chevron seal more forcibly contacting the shaft 132 and the void 344 of the sealing member 310 in the second portion 330 thereof. Thus upon detection of leaks of gas and/or granules through the void 344 of the sealing member 310 around the shaft 132, the jam nut 360 can be tightened to compress and thus outwardly expand the chevron seal 350 to repair the leaks.

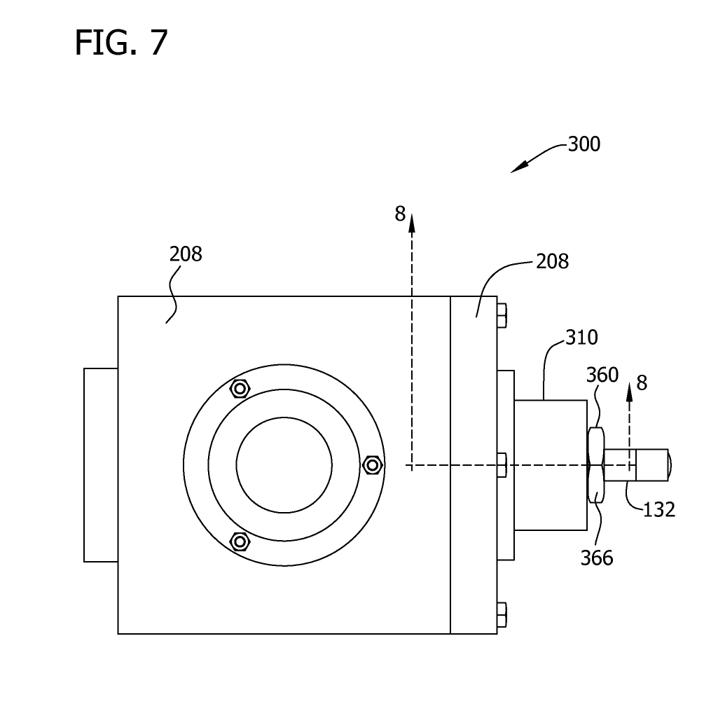

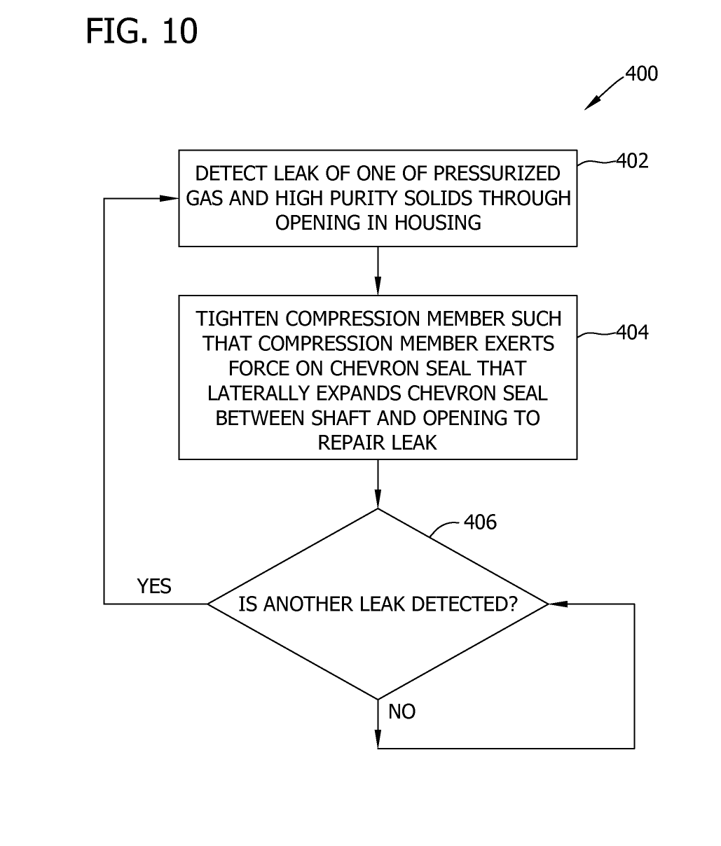

FIG. 10 depicts a method 400 of repairing leaks in an angle of repose valve of the type described above in FIGS. 7-9. The method begins at block 410 with the detection of a leak of pressurized gas through the void in the sealing member. The leak may be detected through any suitable method, such as a decrease in pressure of the gas within the housing of the angle of repose valve, by visual inspection, or during a pressure test performed with water or any other suitable fluid. Moreover, while leaks of pressurized gas are discussed herein, granules having a diameter of less than about 0.060 inches (i.e., dust) may also leak through the void in the sealing member in some embodiments.

The jam nut is then tightened in block 420 by a first amount when the leak is detected. Tightening the jam nut by the first amount results in a force being exerted by the leading edge of the jam nut against the chevron seal that expands the chevron seal laterally between the shaft and the opening in the sealing member. This lateral expansion of the chevron seal functions to repair the leak of pressurized gas through the sealing member. Tightening of the jam nut by the first amount and the corresponding expansion of the chevron seal, while repairing (e.g., stopping) the leak, still permits rotation of the shaft such that the saddle can be rotated between the first and second positions described above.

The method then continues to block 430 where a determination is made if another leak (broadly, a “second leak”) of pressurized gas through the void in the sealing member is detected. If such a leak is not detected in block 430, the method remains at block 430 until the leak is detected. However, if such a leak of pressurized gas and/or granules is detected, the method 400 returns to block 420 where the jam nut is tightened by a second amount to exert additional pressure on the chevron seal. This additional pressure exerted on the chevron seal functions to further expand the chevron seal against the circumferential surface of the void and the shaft to repair the second leak. Even when tightened by this second amount, the chevron seal still permits rotation of the shaft such that the saddle can be rotated between the first and second positions described above.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of the present invention or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

What is claimed is:

1. An angle of repose valve for dispensing granules, the valve comprising:
a housing having an inlet, an outlet, an opening having a circumferential edge, and an interior cavity;
a pipe extending from the inlet into the interior cavity of the housing, the pipe having a terminal end in the interior cavity of the housing;
a saddle disposed in the interior cavity of the housing, the saddle disposed vertically below the terminal end of the pipe, the saddle having a catch member;
a shaft coupled to the saddle, the shaft extending through the circumferential edge of the opening in the housing and configured for coupling to a drive;
a chevron seal disposed adjacent at least the circumferential edge defining the opening in the housing through which the shaft extends, the chevron seal having a void through which the shaft passes;
a compression member engaged with the housing, the compression member configured to exert force on the chevron seal to expand the chevron seal against at least one of the circumferential edge of the opening in the housing and the shaft; and
wherein the saddle is rotatable by the shaft between a first position and a second position, wherein in the first position granules are enabled to flow unimpeded past the catch member, and wherein in the second position the catch member is disposed vertically beneath the terminal end of the pipe such that granules cannot flow past the saddle.

2. The angle of repose valve of claim 1 wherein the compression member has an opening formed therein, the opening being parallel to a longitudinal axis of the compression member, and wherein the shaft extends through the opening in the housing, the void in the chevron seal, and the opening in the compression member.

3. The angle of repose valve of claim 1 wherein the compression member has an external surface and wherein a plurality of threads are disposed on at least a portion of the external surface.

4. The angle of repose valve of claim 3 further comprising a seal plate coupled to an external surface of the housing, wherein the seal plate has an opening formed therein disposed adjacent the opening in the housing and wherein the compression member is threadably engaged with the seal plate.

5. The angle of repose valve of claim 4 wherein the opening in the seal plate has an inner surface and wherein a plurality of threads are disposed on the internal surface of the opening in the seal plate.

6. The angle of repose valve of claim 5 wherein the plurality of threads of the seal plate are engaged with the plurality of threads of the compression member.

7. The angle of repose valve of claim 6 wherein when the compression member is rotated in one of a clockwise and a counterclockwise direction the compression member exerts a force on the compression member that expands the compression member in a lateral direction perpendicular to a longitudinal axis of the shaft.

8. An angle of repose valve for dispensing granules, the valve comprising:
a housing having an inlet and an outlet, the housing comprising a plurality of walls having a thickness of at least about 0.95 inches;
a pipe extending from the inlet into an interior cavity of the housing, the pipe having a terminal end in the interior cavity of the housing;
a saddle disposed in the interior cavity of the housing, the saddle disposed vertically below the terminal end of the pipe, the saddle coupled to a shaft extending through an opening in the housing; and
a seal plate coupled to an exterior surface of the housing, the seal plate having an opening therein disposed adjacent the opening in the housing, the seal plate having a groove formed therein sized for receiving an o-ring, the seal plate configured such that the valve is able to dispense the granules with a gas having a pressure of at least about 80 pounds per square inch.

9. The angle of repose valve of claim 8 further comprising a first o-ring disposed between the exterior surface of the housing and the groove formed in the seal plate and a second o-ring disposed between the shaft and the opening in the seal plate.

10. The angle of repose valve of claim 8 further comprising a valve disposed adjacent the outlet of the housing.

11. The angle of repose valve of claim 8 wherein the saddle has an opening and is rotatable by the shaft between a first position and a second position, wherein in the first position granules are enabled to flow through the opening in the saddle, and wherein in the second position granules cannot flow through the opening in the saddle.

12. An angle of repose valve for dispensing granules with a pressurized gas, the valve comprising:
a housing having an inlet, an outlet, an opening having a circumferential edge, and an interior cavity, the housing having a plurality of walls having a thickness of at least about 0.95 inches;
a pipe extending into the interior cavity of the housing and having a terminal end in the internal cavity;
a saddle disposed in the interior cavity of the housing, the saddle disposed vertically below the terminal end of the pipe,
a shaft coupled to the saddle and extending through the opening in the housing;
a chevron seal disposed adjacent at least the circumferential edge of the opening in the housing through which the shaft extends, the chevron seal having a void through which the shaft passes; and
a compression member threadably engaged with the housing, the compression member configured to exert force on the chevron seal when rotated in one of a clockwise direction and a counter clockwise direction, the force exerted on the chevron seal causing it to expand against at least one of the circumferential edge of the opening in the housing and the shaft.

13. The angle of repose valve of claim 12 wherein the compression member has an opening formed therein, the opening being parallel to a longitudinal axis of the compression member, and wherein the shaft extends through the opening in the housing, the void in the chevron seal, and the opening in the compression member.

14. The angle of repose valve of claim 12 wherein the compression member has an external surface and wherein a plurality of threads are disposed on at least a portion of the external surface.

15. The angle of repose valve of claim 14 further comprising a seal plate coupled to an external surface of the housing, wherein the seal plate has an opening formed therein disposed adjacent the opening in the housing, wherein the compression member is threadably engaged with the seal plate.

16. The angle of repose valve of claim 15 wherein the opening in the seal plate has an inner surface and wherein a plurality of threads are disposed on the internal surface of the opening in the seal plate, and wherein the plurality of threads of the seal plate are engaged with the plurality of threads of the compression member.

17. The angle of repose valve of claim 16 wherein when the compression member is rotated in one of a clockwise and a counterclockwise direction the compression member exerts a force on the compression member that expands the compression member in a lateral direction perpendicular to a longitudinal axis of the shaft.

18. A method of repairing a leak in an angle of repose valve for dispensing granules with a pressurized gas, the angle of repose valve comprising a housing and a saddle disposed therein, a shaft coupled to the saddle and extending through an opening in the housing, a chevron seal positioned between the shaft and the opening in the housing, a compression member threadably engaged with the housing and configured to exert a compression force on the chevron seal upon tightening of the compression member, the method comprising:
detecting a first leak of one of the pressurized gas and granules through the opening in the housing; and
tightening the compression member by a first amount when the first leak is detected, wherein tightening the compression member by the first amount results in a first force being exerted on the chevron seal, wherein the first force exerted on the chevron seal expands the chevron seal laterally between the shaft and the opening in the housing to repair the first leak by reducing or eliminating the first leak, wherein tightening the compression member by the first amount permits rotation of the shaft with respect to the opening in the housing.

19. The method of claim 18 wherein tightening the compression comprises rotating the compression member in one of a clockwise direction and a counterclockwise direction.

20. The method of claim 21 wherein tightening of the compression member results in movement of the compression member in a direction parallel to a longitudinal axis of the shaft towards the housing.

21. The method of claim 20 wherein movement of the compression member in the direction parallel to the longitudinal axis of the shaft towards the housing results in the force being exerted on the chevron seal.

22. The method of claim 18 further comprising detecting a second leak of one of the pressurized gas and granules through the opening in the housing.

23. The method of claim 22 further comprising tightening the compression member a second amount when the second leak is detected, wherein tightening the compression member by the second amount results in a second force being exerted on the chevron seal, wherein the second force exerted on the chevron seal expands the chevron seal laterally between the shaft and the opening in the housing to reduce or eliminate the second leak.

24. The method of claim 23 wherein tightening the seal by the second amount permits rotation of the shaft with respect to the opening in the housing
